(19) United States
(12) Patent Application Publication
(10) Pub. No.: US 2013/0080301 A1
(43) Pub. Date: Mar. 28, 2013

(54) ONE-STEP POSTING FOR APPROVAL-BASED LEDGER TRANSACTIONS

(71) Applicants: Djiao Mei Siauw, Redwood City, CA (US); Deborah Ogg, Los Altos, CA (US); Srini Pala, San Jose, CA (US); David Haimes, Belmont, CA (US); Robert Zwiebach, San Mateo, CA (US); Kalpana Vora, San Francisco, CA (US)

(72) Inventors: Djiao Mei Siauw, Redwood City, CA (US); Deborah Ogg, Los Altos, CA (US); Srini Pala, San Jose, CA (US); David Haimes, Belmont, CA (US); Robert Zwiebach, San Mateo, CA (US); Kalpana Vora, San Francisco, CA (US)

(73) Assignee: Oracle International Corporation, Redwood Shores, CA (US)

(21) Appl. No.: 13/489,135

(22) Filed: Jun. 5, 2012

Related U.S. Application Data
(60) Provisional application No. 61/539,079, filed on Sep. 26, 2011.

(51) Int. Cl. G06Q 40/00

(52) U.S. Cl. 705/30

(57) ABSTRACT

Various arrangements for posting a journal entry to a ledger are presented. The journal entry that comprises financial information related to a credit or debit from an account may be received. A request to post the journal entry to the ledger may be received. The journal entry may be determined to be subject to an approval process at least based on the ledger. At least one entity that is required to approve the journal entry as part of the approval process may be identified. An approval from the at least one entity may be received. After receiving approval, the journal entry may be posted to the ledger such that the ledger indicates the credit or debit of the journal entry. Posting of the journal entry to the ledger may require no input from the user following receiving the request to post the journal entry to the ledger.

### CROSS-REFERENCES TO RELATED APPLICATIONS

This application claims priority to co-pending provisional application No. 61/539,079, filed Sep. 26, 2011, entitled “Mechanism to Automatically Submit One-Step Posting for a Transaction that is Submitted for Approval Process,” the entire disclosure of which is hereby incorporated by reference for all purposes.

### BACKGROUND

Businesses often maintain ledgers that serve as records of debits and credits to one or more financial accounts. In some businesses, before an employee of the business is permitted to post a transaction to the ledger, the transaction must be approved by another employee, such as the employee's manager. In such an arrangement, the employee may submit the change to the manager for approval. After the manager has approved the change, the employee may then be permitted to cause the transaction to be posted to the ledger. Once posted to the ledger, the transaction may be visible to all parties that access the ledger.

### SUMMARY

In various embodiments, arrangements for posting a journal entry to a ledger are presented. In some embodiments, a method for posting a journal entry to a ledger is presented. The method may include receiving, by a computer system, from a user, the journal entry that comprises financial information related to a credit or debit from an account, with a request to post the journal entry to the ledger. The journal entry may correspond to the ledger. The method may include determining, by the computer system, that the journal entry is subject to an approval process. The method may include, after receiving the request to post the journal entry to the ledger, identifying, by the computer system, at least one other user required to approve the journal entry as part of the approval process. The method may include receiving, by the computer system, an approval from the at least one other user. The method may include, after receiving the approval from the at least one other user, posting the journal entry to the ledger such that the ledger indicates the credit or debit of the journal entry. Posting of the journal entry to the ledger may require no additional input from the user who submitted the journal entry following receiving the request to post the journal entry to the ledger received with the journal entry.

Embodiments of such a method may include one or more of the following: The method may further include determining, by the computer system, using a rule applicable to the ledger, that the ledger is subject to the approval process. Identifying the at least one other user required to approve the journal entry as part of the approval process may be performed using a BPEL business process. Identifying the at least one other user may be at least partially based on a stored indication of a manager of the user. The method may include transmitting, by the computer system, an approval request to the at least one other user. The method may include storing, by the computer system, an indication, linked with the journal entry, that indicates the journal entry has posted to the ledger. The method may include, after receiving the approval from the at least one other user, transmitting a notification to the user indicating the journal entry has been posted to the ledger.

In some embodiments, a computer program product residing on a non-transitory processor-readable medium for posting a journal entry to a ledger is presented. The computer program product comprising processor-readable instructions may be configured to cause a processor to receive, from a user, the journal entry that comprises financial information related to a credit or debit from an account, with a request to post the journal entry to the ledger, wherein the journal entry corresponds to the ledger. The processor-readable instructions may be further configured to cause the processor to determine that the journal entry is subject to an approval process. The processor-readable instructions may be further configured to cause the processor to, after receiving the request to post the journal entry to the ledger, identify at least one other user required to approve the journal entry as part of the approval process. The processor-readable instructions may be further configured to cause the processor to receive an approval from the at least one other user. The processor-readable instructions may be further configured to cause the processor to, after receiving the approval from the at least one other user, cause the journal entry to be posted to the ledger such that the ledger indicates the credit or debit of the journal entry. Posting of the journal entry to the ledger may require no additional input from the user who submitted the journal entry following receiving the request to post the journal entry to the ledger received with the journal entry.

Embodiments of such a computer program product may include one or more of the following: The computer program product may further comprise processor-readable instructions configured to cause the processor to determine, using a rule applicable to the ledger, that the ledger is subject to the approval process. The processor-readable instructions may be configured to cause the processor to identify the at least one other user required to approve the journal entry as part of the approval process is performed using a BPEL business process. The processor-readable instructions may be configured to cause the processor to identify the at least one other user, at least partially bases identification on a stored indication of a manager of the user. The computer program product may further comprise processor-readable instructions configured to cause the processor to cause an approval request to be transmitted to the at least one other user. The computer program product may further comprise processor-readable instructions configured to cause the processor to cause an indication linked with the journal entry to be stored, wherein the indication indicates the journal entry has posted to the ledger. The computer program product may further comprise processor-readable instructions configured to cause the processor to after receiving the approval from the at least one other user, cause a notification to the user indicating the journal entry has been posted to the ledger to be transmitted.

In some embodiments, a system for posting a journal entry to a ledger is presented. The system may include a processor. The system may include a memory communicatively coupled with and readable by the processor. The memory may have stored therein processor-readable instructions which, when executed by the processor, cause the processor to receive, from a user, the journal entry that comprises financial information related to a credit or debit from an account, with a request to post the journal entry to the ledger, wherein the journal entry corresponds to the ledger. The memory may have stored therein processor-readable instructions which, when executed by the processor, cause the processor to determine that the journal entry is subject to an approval process. The memory may have stored therein processor-readable instructions which, when executed by the processor, cause the processor to, after receiving the request to post the journal entry to the ledger, identify at least one other user required to approve the journal entry as part of the approval process. The memory may have stored therein processor-readable instructions which, when executed by the processor, cause the processor to receive an approval from the at least one other user. The memory may have stored therein processor-readable instructions which, when executed by the processor, cause the processor to, after receiving the approval from the at least one other user, cause the journal entry to be posted to the ledger such that the ledger indicates the credit or debit of the journal entry. Posting of the journal entry to the ledger may require no additional input from the user who submitted the journal entry following receiving the request to post the journal entry to the ledger received with the journal entry.

Embodiments of such a system may include one or more of the following: The memory may further have stored therein processor-readable instructions configured to cause the processor to determine, using a rule applicable to the ledger, that the ledger is subject to the approval process. The processor-readable instructions may be configured to cause the processor to identify the at least one other user required to approve the journal entry as part of the approval process is performed using a BPEL business process. The processor-readable instructions may be configured to cause the processor to identify the at least one other user, at least partially bases identification on a stored indication of a manager of the user. The memory further having stored therein processor-readable instructions may be configured to cause the processor to cause an approval request to be transmitted to the at least one other user. The memory may further have stored therein processor-readable instructions configured to cause the processor to cause an indication linked with the journal entry to be stored, wherein the indication indicates the journal entry has posted to the ledger.

### BRIEF DESCRIPTION OF THE DRAWINGS

A further understanding of the nature and advantages of various embodiments may be realized by reference to the following figures. In the appended figures, similar components or features may have the same reference label.

FIG. 1 illustrates an embodiment of a system configured for posting a journal entry to a ledger.

FIG. 2 illustrates an embodiment of a system configured for posting a journal entry to a ledger, wherein a user is submitting the journal entry.

FIG. 3 illustrates an embodiment of a system configured for posting a journal entry to a ledger, wherein approval of the journal entry from a manager is requested.

FIG. 4 illustrates an embodiment of a system configured for posting a journal entry to a ledger, wherein a manager has approved the journal entry and the journal entry is posted.

FIG. 5A illustrates an embodiment of a user interface for posting a journal entry to a ledger.

FIG. 5B illustrates an embodiment of a user interface for confirming that a journal entry has been submitted for approval before posting to a ledger.

FIG. 5C illustrates an embodiment of a user interface for determining the status of journal entries submitted for posting to a ledger.

FIG. 6A illustrates an embodiment of a user interface for approving the posting of a journal entry to a ledger.

FIG. 6B illustrates an embodiment of a user interface for confirming that a journal entry has been approved by the approving user.

FIG. 7 illustrates an embodiment of a method for posting a journal entry to a ledger.

FIG. 8 illustrates another embodiment of a method for posting a journal entry to a ledger.

FIG. 9 illustrates an embodiment of a computer system.

### DETAILED DESCRIPTION

One-step posting can allow for submission for approval of a journal entry and posting of the journal entry to be completed by a user submitting the journal entry in a single step. A user may first create a journal entry. The journal entry may contain one or more debits and/or credits against a ledger. The ledger may be used for recording and totaling monetary transactions by account, including debits and credits (referred to as “transactions”), a beginning balance, and an ending balance for each account. Therefore, each transaction involving an account may need to be recorded to the ledger such that the ledger reflects the accurate balance of the account. In order for a user, such as an employee of a business, to have permission to update a ledger with a journal entry that indicates one or more new transactions, the journal entry may be required to be approved by one or more other users that have approval power over the user's journal entries.

Therefore, when the user submits a journal entry, the user may indicate that the journal entry is to be posted to a particular ledger. When submitting the journal entry, the user indicates that the journal entry is to post to the ledger. It may be determined that an approval process must be successfully completed before the journal entry is posted to the ledger. Until that time, the ledger may remain un-updated and the journal entry may remain in a pending state. An indication of the journal entry may be sent to one or more other users, such as the user's manager, for approval. Once each of the requisite other users have approved the journal entry, the journal entry may be changed from a pending state to a posted state. The ledger may then be updated to reflect the transactions of the journal entry. As such, any user that views the ledger after the journal entry has posted may be able to see the transactions of the journal entry posted within the ledger.

Once the user has initially indicated that the journal entry is to be posted to the ledger (which may occur at the time the journal entry is created and submitted), no further input from the user may be necessary during the approval and posting process. As such, once the user provides a single input that designates the journal entry for posting (or posting and approval), the journal entry may be moved through the approval process and posted to the ledger without any further action required by the user. While in previous arrangements separate actions by the user may have been necessary to conduct an approval process and then post, in the embodiments detailed herein, approval and posting have been combined into a single step request for the user that is submitting the journal entry.

Only particular ledgers of a business's ledgers may require approval for journal entries to be posted. When a journal entry is submitted by a user for posting to the ledger, a check may be performed to determine if approval is required for posting to the ledger. If not, the journal entry may update the ledger without any approval process. If an approval process is enabled for the particular ledger, a check may be performed based on the user to determine: whether approval is necessary for journal entries submitted by the user, and, if at least one approval is required, which other users are required to provide the approval. While an approval process may be enabled for a ledger, an approval may not necessarily be required for the particular journal entries submitted by the user. For instance, based on the user's designation (e.g., job title) and/or the monetary amount of transactions of the journal entry, approval may not be required. If approval is required from multiple other users, a request for approval may be sent to each other user that must be approved in parallel (at the same time) or in series (when one of the other users approves, the next user in line that must approve the journal entry receives a request for approval).

Determining what, if any, approval process applies to the journal entry may be performed using a Business Process Execution Language (BPEL) process that may be configured for a business's specific needs. As such, specifically which users must have journal entries approved and/or by whom the journal entries are approved may be configured for a specific business. During the approval process, it may be possible for the user that submitted the journal entry to check the status of the journal entry. Once an approval process has been completed, the user may be notified that the journal entry has been approved and has posted to the ledger. The journal entry may then be designated as posted.

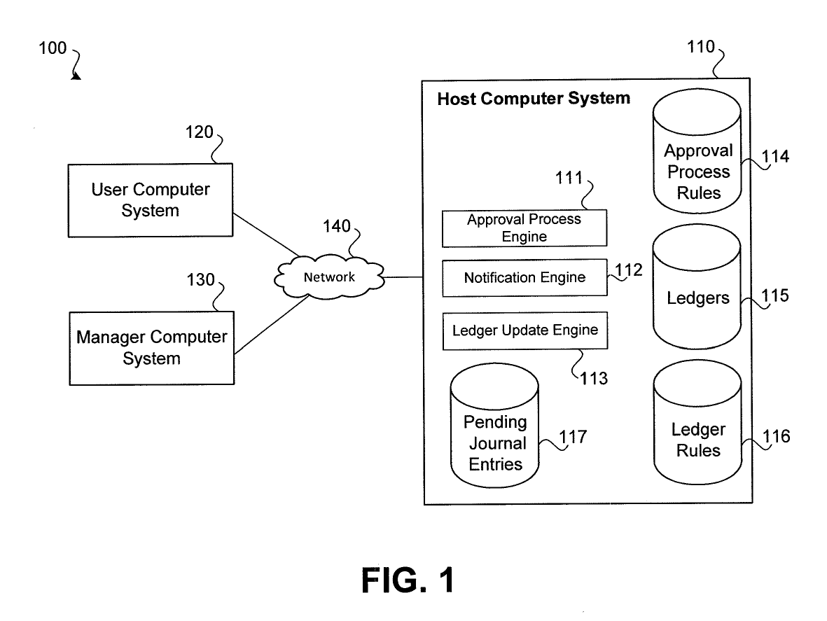

FIG. 1 illustrates an embodiment of a system 100 configured for posting a journal entry to a ledger. System 100 may be used to perform the various arrangements detailed above. System 100 may include: host computer system 110, user computer system 120, manager computer system 130, and network 140. Host computer system 110 may include: approval process engine 111, notification engine 112, ledger update engine 113, approval process rules 114, ledgers 115, ledger rules 116, and pending journal entries 117.

User computer system 120 represents a computer system that a user may use to create and/or submit a journal entry. A journal entry may identify one or more transactions that should be posted to a ledger associated with one or more particular financial accounts. For instance, a journal entry may specify a credit, a debit, a transfer, or some other type of financial transaction that affects funds within a financial account. User computer system 120 may represent various types of computerized devices, such as a desktop, laptop, tablet, smart phone, or some other form of computerized device. User computer system 120 may be configured to execute or otherwise present an interface to a user that can be used to create and/or submit journal entries.

Manager computer system 130 represents a computer system that another user may use to approve a journal entry submitted by the user via user computer system 120. It should be understood that functionally user computer system 120 and manager computer system 130 may be similar or identical, the difference being the roles of the users operating the respective computer systems. Manager computer system 130 may represent various types of computerized devices, such as a desktop, laptop, tablet, smart phone, or some other form of computerized device. Manager computer system 130 may be configured to execute or otherwise present an interface to a user that can be used to approve and/or deny journal entries.

In system 100 of FIG. 1, a single user computer system and a single manager computer system are illustrated. It should be understood that this is for simplicity only. In other embodiments, greater numbers of computer systems may function as user computer systems and/or greater numbers of computer systems may function as manager computer systems. For a particular journal entry, approval may be required from one or more than one managers (or some other type of user that is permitted to approve journal entries). As such, multiple manager computer systems may receive requests for such approvals. Requests for approvals may be routed to different mangers (and, thus, possibly different manager computer systems) depending on the identity of the user, the type of journal entry, and/or the ledger (to name only a few examples).

User computer system 120 and manager computer system 130 may communicate with host computer system 110 via network 140. Network 140 may represent one or more pubic and/or private networks. A public network may be the Internet; a private network may be a corporate intranet and/or a (cellular) wireless network. While user computer system 120 and manager computer system 130 are illustrated in FIG. 1 as in communication with host computer system 110 via network 140, such computer systems can, in some embodiments, be in direct communication (e.g., without the use of a network) with host computer system 110.

Host computer system 110 may include multiple components and datastores. Approval process engine 111 may determine if an approval process is necessary to update a ledger indicated by a received journal entry. If approval is required, approval process engine 111 may determine which other users are required to approve the journal entry. Approval process engine 111 may receive a journal entry from user computer system 120. Approval process engine 111 may inspect the journal entry to determine which user has submitted the journal entry and which ledger the journal entry corresponds to.

Approval process engine 111 may communicate with one or more databases. Ledger rules 116 may be a database (or some other data storage arrangement) that stores rules that correspond to particular ledgers. Ledger rules 116 may define rules that apply to all users that interact with particular ledgers. For instance, some ledgers may have a rule indicating if an approval process is necessary. Other rules that may be specific to a particular ledger may include the source of journal entries or transactions that require approval. Approval process engine 111 may access ledger rules 116 to determine the rules that govern the ledger that a journal entry is intended to be posted to.

During the approval process, such as waiting for users to respond with an approval or denial, pending journal entries may be maintained in pending journal entries 117. Pending journal entries 117 may be in the form of a database or some other type of data storage arrangement. Such pending journal entries may be indicated as pending and may be stored by pending journal entries 117 until approvals and/or denials have been received from all requisite users, such as a manager that operates manager computer system 130.

Approval process rules 114 may be in the form of a database or some other type of storage arrangement. Approval process rules 114 may define rules that apply to users that submit journal entries. For instance, approval process rules 114 may apply to specific users (e.g., John Doe), specific types of users (e.g., persons with a specific job title), and/or users with a specific permission level (e.g., approval-required level, limited approval-required level). Approval process rules 114 may also be used to determine one or more other users that are required to approve the journal entry. The users that are required to give the approval may be specifically named or may be determined based on a hierarchy, such as a manager responsible for a user identified as requiring to approve the journal entries of the user. As an example, if a user has a specific job title of general accountant, a general accounting manager may be required to approve the user's journal entry. A lookup in approval process rules 114 may be performed to determine the particular account manager responsible for approving the account assistant.

Notification engine 112 may send requests for approval to users that are required to approve a journal entry received from user computer system 120. The notifications may be in the form of an email, a text message, a desktop notification, or some other form of request that indicates to the users that approval is required. In some embodiments, the notification may include a copy of the journal entry or at least some of the information present in the journal entry. By responding to the notification, the users that are required to approve the journal entry may be able to either approve or deny the journal entry. In some embodiments, the users may be permitted to edit the journal entry. In some embodiments, the notification may serve as an indication to log into host computer system 110 in order to approve or deny the journal entry. In some embodiments, no notification is sent to the approving users, but a listing of pending journal entries is presented to each user following login.

When a user responds to a request for approval by approving the journal entry, approval process engine 111, possibly in conjunction with notification engine 112, may notify one or more additional users that approval is required (if required by approval process rules 114 and/or ledger rules 116). Once all of the requisite approvals have been obtained, the approval process may be completed and ledger update engine 113 may be used to update the corresponding ledger of ledgers 115.

If a user that is required to approve a journal entry denies it (or modifies it), notification engine 112 may notify the user (possibly at user computer system 120) that the journal entry has been denied. If the user who denied the journal entry provided a reason, the reason may be presented to the user who submitted the journal entry. This notification may be in the form of an email, text message, desktop notification, and/or a message that requires the user to log into host computer system 110 to view the details of the rejection. The user may be permitted to modify and/or otherwise correct the journal entry and resubmit for approval.

Once a journal entry has been approved by all of the requisite users, posting of the journal entry to the appropriate ledger may occur without any further involvement from the user who submitted the journal entry and/or any other user (such as users who approved entries). Approval process engine 111 may provide an indication to ledger update engine 113 that a particular pending journal entry of pending journal entries 117 is available for posting to a corresponding ledger of ledgers 115. Ledgers 115 may represent a database or other data storage arrangement where multiple ledgers of an enterprise are maintained. A particular journal entry may correspond to a particular ledger.

Ledger update engine 113 may update a ledger of ledgers 115 with the approved journal entry of pending journal entries 117. The updated ledger may now reflect the one or more transactions of the journal entry. As such, a user that views the ledger of ledgers 115 may be able to see the transactions of the journal entry that have been approved and posted to the ledger. The approved and posted journal entry may be demarked as approved and/or posted. Notification engine 112 may transmit an indication to the user that submitted the journal entry indicating that the journal entry has been posted to the corresponding ledger.

In FIG. 1, host computer system 110 contains multiple databases and component engines. It should be understood that such databases may be combined into fewer data storage arrangements and/or divided into more data storage arrangements. Further, in other embodiments, such data stores may be local and/or remote (e.g., available via network 140) from host computer system 110. The component engines of host computer system 110 may likewise be combined or divided into additional component engines. Further, such engines may be executed by a single computer system or executed in a distributed manner by multiple computers. For example, host computer system 110 may include multiple servers.

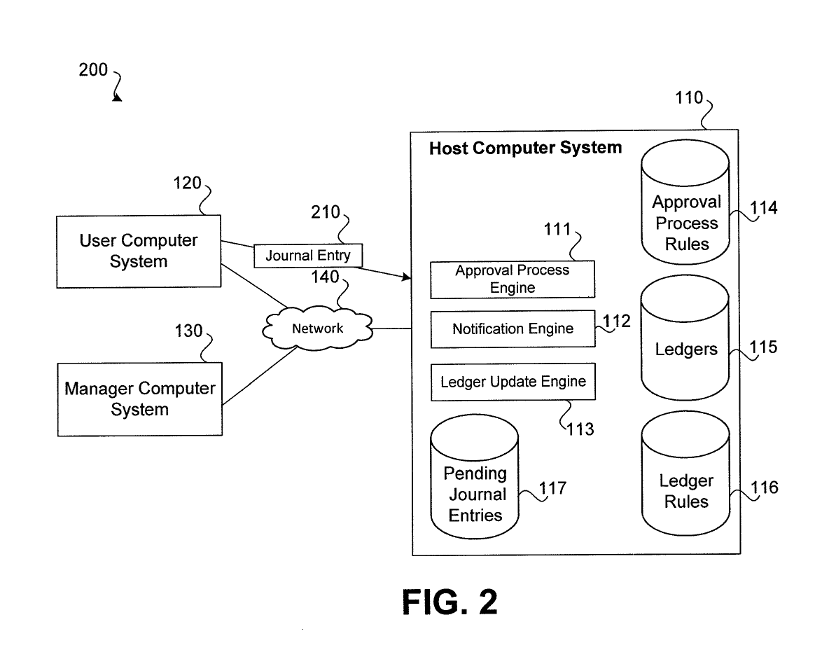

FIG. 2 illustrates an embodiment of a system 200 for posting a journal entry to a ledger, wherein a user is submitting the journal entry. System 200 may represent an embodiment of system 100 of FIG. 1. In system 200, a journal entry 210 is being submitted by user computer system 120 to host computer system 110. Journal entry 210 may be submitted from user computer system 120 to host computer system 110 via network 140.

Journal entry 210 may indicate one or more credit and/or debit transactions that are desired by a user (that is operating user computer system 120) to be posted against a particular ledger of ledgers 115. Journal entry 210 may also indicate: the user attempting to post the transactions, the amount of the transactions, descriptions of the transactions, dates and/or times of the transactions, etc. The user of user computer system 120 may have submitted journal entry 210 with an indication that journal entry 210 be posted to a particular ledger. Requesting such posting may have been a single step from the point of view of the user. As such, submission of the journal entry, a request for approval of the journal entry, and a request for posting of the journal entry may be a single input from the user. Approval may be obtained for the journal entry as part of the posting process. The approval process may be invisible to the user.

Upon receiving journal entry 210, approval process engine 111 may access ledger rules 116 to determine what, if any, rules apply to the ledger which journal entry 210 corresponds to. Approval process engine 111 may additionally or alternatively access approval process rules 114 to determine what, if any, approval rules apply to the user that submitted journal entry 210. Journal entry 210 may be designated part of pending journal entries 117 until journal entry 210 is approved or denied.

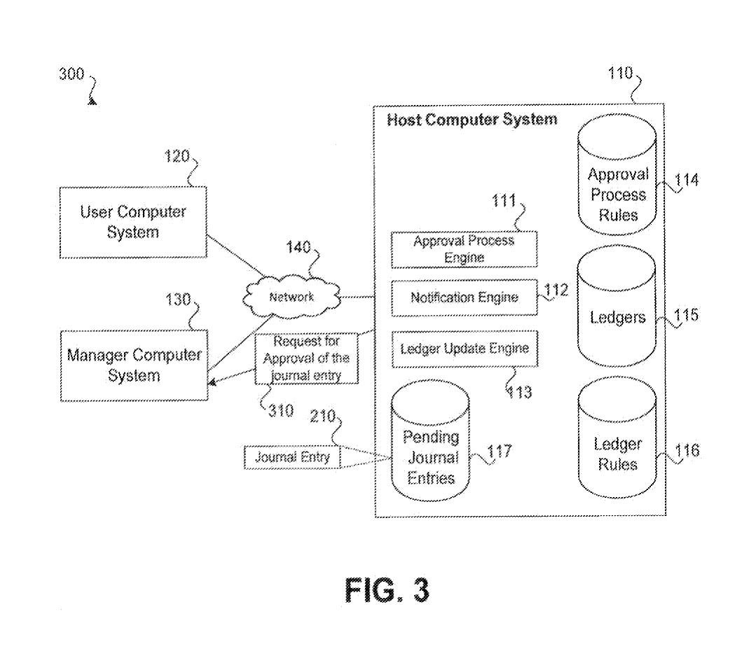

FIG. 3 illustrates an embodiment of a system for posting a journal entry to a ledger, wherein approval of the journal entry from a manager is requested. System 300 may represent an embodiment of system 100 of FIG. 1 and/or an embodiment of system 200 of FIG. 2. In FIG. 3, journal entry 210 is stored with pending journal entries 117. At this point, the ledger associated with journal entry 210 may not be updated to include the one or more transactions indicated by journal entry 210.

Approval process engine 111 may determine which, if any, approvals from other users are necessary before journal entry 210 may be posted to the corresponding ledger. Notification engine 112 may transmit a request for approval 310 of the journal entry to a user that is required to approve the journal entry. Details (e.g., a copy) of the journal entry may be sent to the appropriate user for approval. As illustrated in system 300 of FIG. 3, request for approval 310 of the journal entry is transmitted to manager computer system 130 via network 140 from host computer system 110. Until the user that is providing approval responds, no further action may be taken with the pending journal entry 210.

In some embodiments, multiple users are required to approve journal entry 210. In some embodiments, request for approval 310 of the journal entry may be sent for approval to multiple users in parallel. As such, requests for approval may be outstanding at the same time. Once approval is received from each (or, in some embodiments, some minimum number of users, such as one) user, journal entry 210 may be approved. As an example, if a journal entry is submitted by a first user, and users two, three, and four are permitted to approve the first user's journal entries, a request for approval 310 of the journal entry may be sent to each of users two, three, and four such that the requests are simultaneously outstanding. Once one of the second, third, or fourth users approves journal entry 210, posting of journal entry 210 may occur to the corresponding ledger of ledgers 115.

In other embodiments, the requests for approval may be sent in a series. In such embodiments, request for approval 310 of the journal entry may only be sent to a third user once a second user has approved journal entry 210. Whether requests for approval of the journal entry are sent in parallel or series may be determined based on ledger rules 116 and/or approval process rules 114.

If a user that receives request for approval 310 of the journal entry denies posting, the approval process may be stopped by approval process engine 111. Notification engine 112 may or may not (depending on approval process rules 114 and/or ledger rules 116) send a message indicating as such to the user that submitted journal entry 210 for posting. Such a notification may be transmitted to user computer system 120.

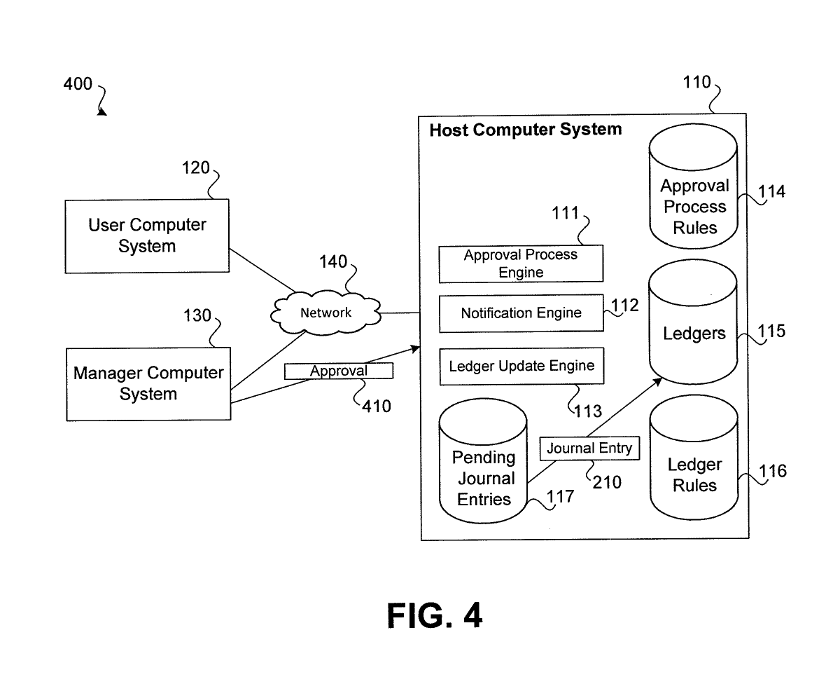

FIG. 4 illustrates an embodiment of a system for posting a journal entry to a ledger, wherein a manager has approved the journal entry and the ledger is updated. System 400 may represent an embodiment of system 100 of FIG. 1, an embodiment of system 200 of FIG. 2, and/or an embodiment of system 300 of FIG. 3. In system 400, an approval is received by host computer system 110 via network 140 from manager computer system 130. Approval 410 indicates that the user operating manager computer system 130 has approved of journal entry 210.

If approval 410 is the only or last approval needed according to ledger rules 116 and/or approval process rules 114 for journal entry 210, and approval 410 indicates that journal entry 210 is approved, the corresponding ledger of ledgers 115 may be updated to reflect the one or more transactions of journal entry 210. Journal entry 210 may be as submitted by the user of user computer system 120 or may have been modified by the one or more users that approved journal entry 210. Posting of journal entry 210 to the appropriate ledger of ledgers 115 may not require any additional input from the user of user computer system 120. As such, once journal entry 210 is submitted by the user of user computer system 120, approval and posting may occur.

When posted, journal entry 210 may be removed from pending journal entries 117. A copy of journal entry 210 may be maintained and designated as posted. Once posted, the associated ledger may reflect the one or more transactions of journal entry 210. Ledger update engine 113 may be responsible, once the necessary approvals have been received, for posting journal entry 210 to the appropriate ledger of ledgers 115.

At any given time, multiple journal entries may be pending with approval required by the same or different users. As such, pending journal entries 117 may include multiple journal entries that are awaiting approval (or denial).

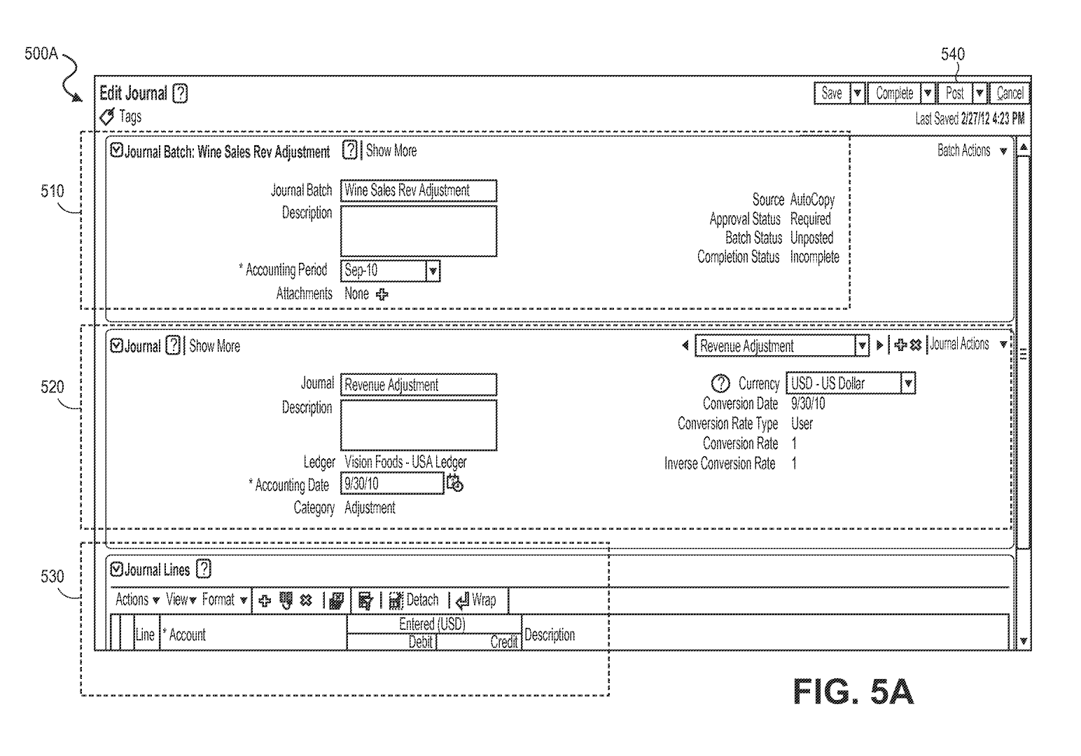

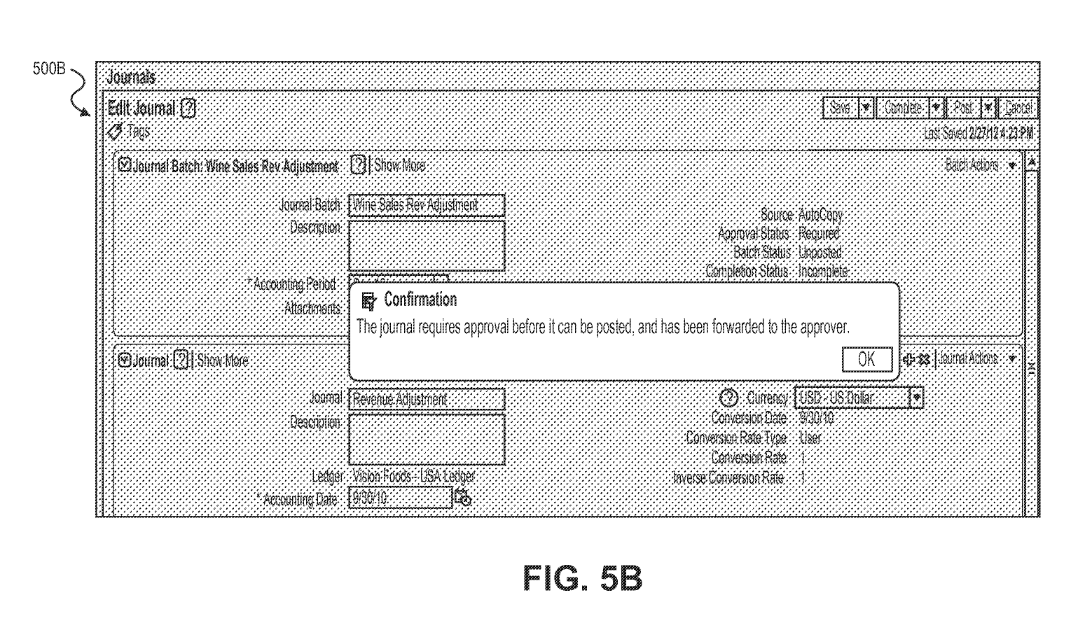

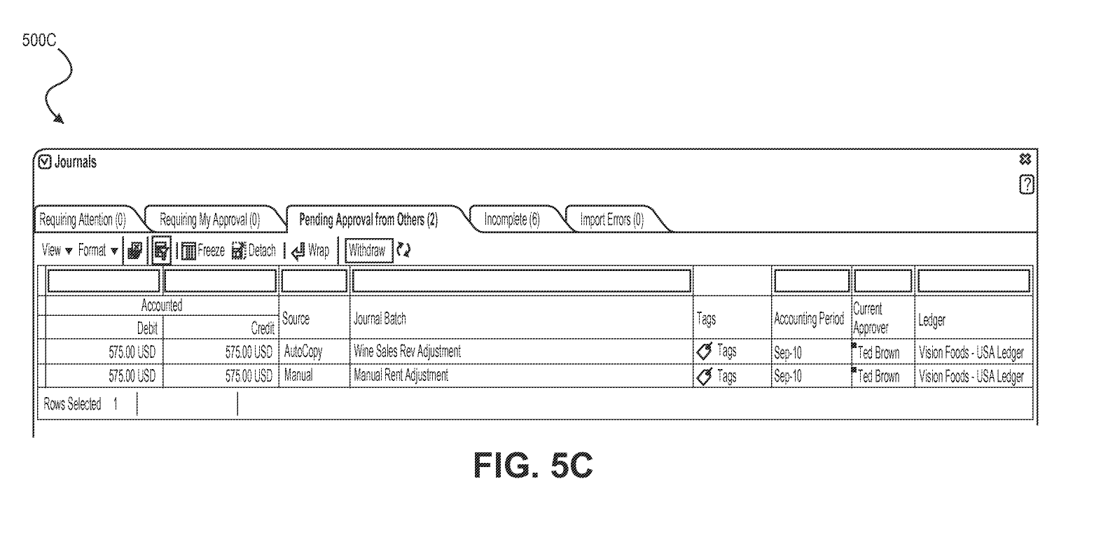

FIG. 5A illustrates an embodiment of a user interface 500A for submitting and posting a journal entry to a ledger. User interface may be presented to a user submitting a journal entry, such as by user computer system 120 of FIG. 1, or some other computerized device used to submit journal entries for posting. For instance, user computer system 120 may present user interface 500A at least partially based on data received from host computer system 110. In region 510, information about a batch of journal entries may be provided. Such batch information may include: a journal batch name, a description, an accounting period, attachments, and/or a source. Some of such batch information may be provided by the user. Other information may be presented for the user's reference, such as whether approval will be required and the system may automatically update the batch with the approval status, batch status, and completion status. Determining whether approval is required may be determined based on ledger rules and/or approval process rules.

Region 520 may allow specific journal details to be selected and a specific ledger to which the journal should be recorded to be selected. In region 520, information such as a journal name, a description, a ledger, an accounting date, a category, a currency, a conversion date, a conversion rate type, a conversion rate, and an inversion conversion rate may be provided. At least some of such information may be submitted by the user. In some embodiments, at least some of such information may be provided for reference to the user.

Region 530 may permit a user to input journal entries, also referred to as journal lines. In this region, an account may be specified, and a debit amount, a credit amount, and/or a description may also be provided.

Element 540 may permit a user to indicate that the journal entry is complete and should be posted. The user selecting element 540 may initiate the journal submission, approval, and posting process. After selecting element 540, no further input may be required from the user to complete the approval and posting process.

FIG. 5B illustrates an embodiment of a user interface 500B for confirming that a journal entry has been submitted for approval before posting to a ledger. For instance, user computer system 120 may present user interface 500B at least partially based on data received from host computer system 110. User interface 500B may be presented to a user submitting a journal entry, such as by user computer system 120 of FIG. 1, or some other computerized device used to submit journal entries for posting. User interface 500B may be presented after a user has selected element 540 of user interface 500A. The message of user interface 500B may serve to inform the user that an approval process will be completed before the journal is posted to the ledger.

FIG. 5C illustrates an embodiment of a user interface 500C for determining the status of journal entries submitted for posting to a ledger. User interface 500C may be presented to a user submitting a journal entry, such as by user computer system 120 of FIG. 1, or some other computerized device used to submit journal entries for posting. For instance, user computer system 120 may present user interface 500C at least partially based on data received from host computer system 110. Using user interface 500C, a user may be able to determine the status of one or more journal entries submitted for posting which are subject to an approval process. Information which may be presented to the user includes who the one or more approvers are, the ledger, the accounting period, tags, the journal batch, the source, and/or the credit and/or debit amount. Other information may also be presented.

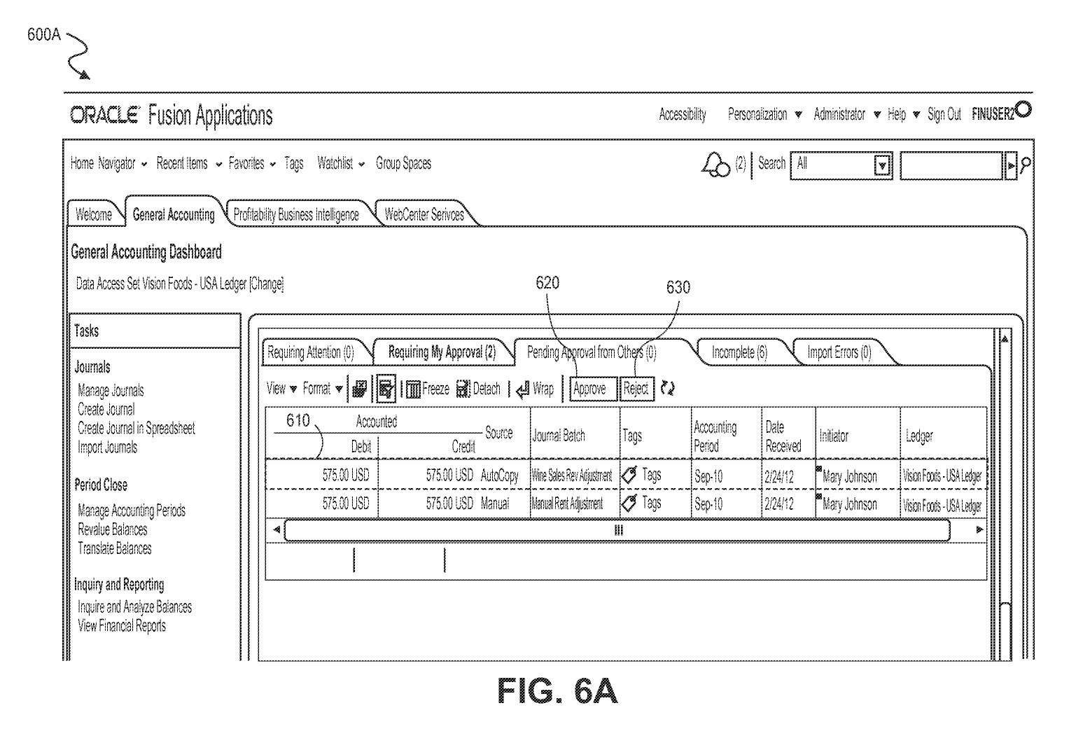

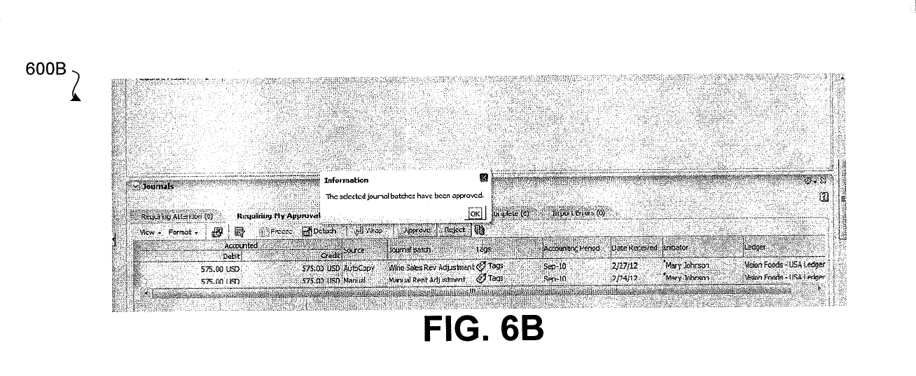

FIG. 6A illustrates an embodiment of a user interface 600A for approving the posting of a journal entry to a ledger. User interface 600A may be presented to a user approving a journal entry, such as by manager computer system 130 of FIG. 1, or some other computerized device used to approve journal entries for posting. For instance, manager computer system 130 may present user interface 600A at least partially based on data received from host computer system 110. The user may be permitted to approve (such as using graphical element 620) or reject (such as using graphical element 630) for each journal entry, such as journal entry 610. Each of these journal entries may be designated as requiring the user's approval (e.g., by a tab that indicates “for my approval”). Information from each journal entry (or a complete copy of the journal entry), such as illustrated, may be presented to the user to allow the user to determine whether to approve or deny. User interface 600A may require a user to log into a system, such as host computer system 110 of FIG. 1.

FIG. 6B illustrates an embodiment of a user interface 600B for confirming that a journal entry has been approved by the approving user. User interface 600B may be presented to a user approving a journal entry, such as by manager computer system 130 of FIG. 1, or some other computerized device used to approve journal entries for posting. For instance, manager computer system 130 may present user interface 600B at least partially based on data received from host computer system 110. After selecting approve via graphical element 620, user interface 600B may be presented to confirm that approval has successfully occurred.

It should be understood that the user interfaces of FIGS. 5 and 6 are for example purposes only. In other embodiments, elements may be rearranged, and/or certain elements may be added and/or subtracted.

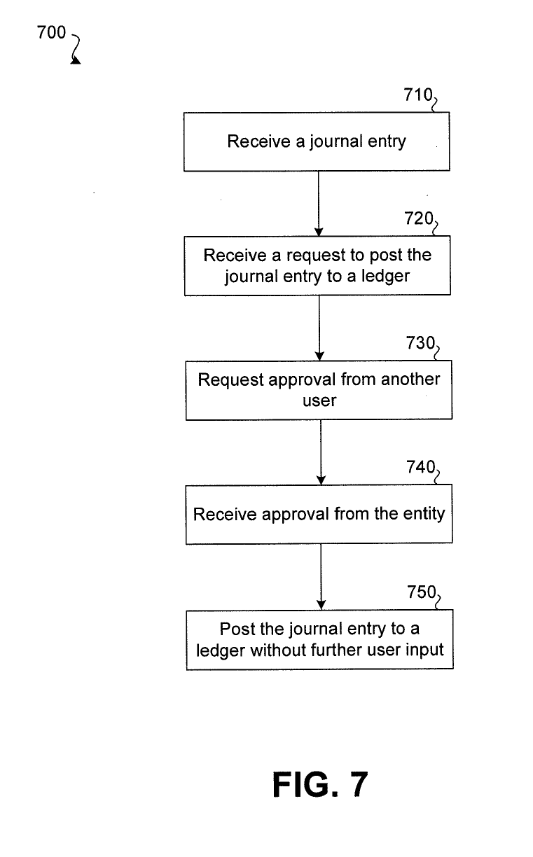

FIG. 7 illustrates an embodiment of a method 700 for posting a journal entry to a ledger. Method 700 may be performed by systems 100 through 400 of FIGS. 1 through 4, respectively. Method 700 may also be performed using some other embodiment of a system that is configured for posting journal entries to a ledger. More generally, each step of method 700 may be performed using a computer system. As such, means for performing method 700 include computerized devices, such as mobile phones, computers, tablet computers, servers, etc.

At step 710, a journal entry may be received. The journal entry may indicate one or more transactions, such as credit and/or debit transactions, that are desired to be posted to a ledger. The ledger may contain accounting entries for one or more financial accounts. As an example, a business may maintain a ledger for all credits and debits to particular bank accounts. As such, where money originated from and where money was distributed to (e.g., spent) may be tracked. The journal entry may include information such as: the user submitting the journal entry, a number of credits and/or debits, an amount of each credit and/or debit, a description of each credit and/or debit, and/or a time and/or date for each transaction. Other information may also be present as part of the journal entry.

Referring to system 100 of FIG. 1, the journal entry may be received by a server, such as host computer system 110 from a remote computer system, such as user computer system 120, operated by the user submitting the journal entry. As such, a journal entry may be submitted from a remote computer system via a network, such as network 140. In some embodiments, the journal entry may be submitted directly to the computer system maintaining the ledger. As such, host computer system 110 may directly receive a journal entry from a user.

As part of (or with) the journal entry, the user who submitted the journal entry may provide an indication that the journal entry is to be posted to a particular ledger. As such, at step 720, a request to post the journal entry to a ledger may be received. This request may be received as part of (or with) the journal entry of step 710. Submission of the journal entry may be based on a user selecting a graphical element that indicates “post.” The selection of the user may only indicate that posting will occur or may also indicate that approval will also occur. Providing only a single input from the user to invoke approval and posting may be possible. As such, based on a single input received from the user, the journal entry may be submitted and received for approval and posting.

At step 730, approval is requested from one or more other users. Such other users may be managers that have permission to approve journal entries. The request may be transmitted to the one or more other users. The request may be transmitted to the other users in the form of an email, text message, desktop notification, etc. The request may contain a copy of the journal entry or selected information from the journal entry. The request may provide the ability to directly approve the journal entry. For example, if the request is in the form of an email, a link may be provided to approve the journal entry. In some embodiments, the other user may be required to log into a system to provide approval or denial of the journal entry. The other user may be permitted to modify the journal entry.

At step 740, the approval may be received from the other user. If multiple approvals of the journal entry are required, multiple approvals (or denials) may be received at step 740. Referring to FIG. 1, the request for approval may be transmitted to another user, such as a manager, at a remote computer system. The request for approval may be transmitted by host computer system 110 to manager computer system 130. Manager computer system 130 may represent a computer system that the manager happens to be using. For instance, if the request is in the form of an email, the computer system that the request is received on may be whichever computer the manager is currently using to access his email account. The approval from the user may be received by host computer system 110 from manager computer system 130. In some embodiments, the other user may directly interact with host computer system 110.

At step 750, assuming each other user that was required to approve the journal entry at step 740 did so approve the journal entry, the journal entry may be posted to the ledger. Posting to the ledger may include updating the appropriate ledger to reflect the one or more transactions of the journal entry. As such, a final account balance reflected by the ledger may change in response to the transactions of the journal entry. Additional details included in the journal entry may be published to the ledger and may become visible to all users that have permission to view the ledger. Posting to the ledger may automatically occur after all of the requisite approvals have been obtained. As such, from the point of view of the user who submitted the journal entry at step 710, once the journal entry is submitted with a request to post, no further action may be necessary. Accordingly, once the approval process has successfully been completed, the journal entry will be posted to the ledger. The journal entry received at step 710 may be demarked as posted.

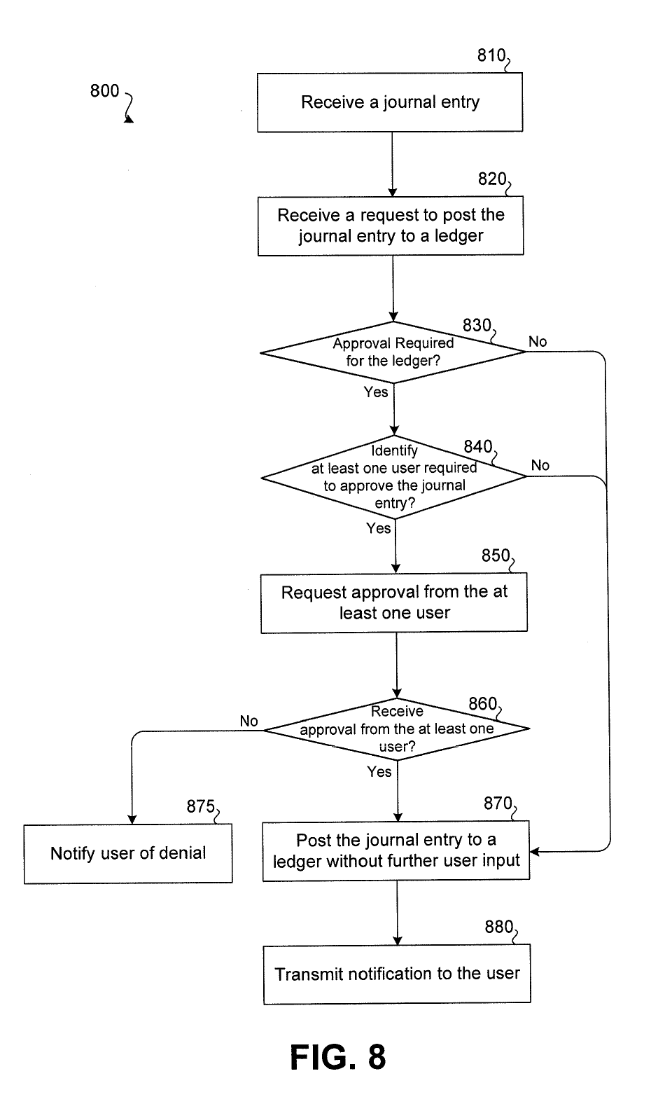

FIG. 8 illustrates another embodiment of a method for posting a journal entry to a ledger. Method 800 may be performed by systems 100 through 400 of FIGS. 1 through 4, respectively. Method 800 may also be performed using some other embodiment of a system that is configured for posting journal entries to a ledger. More generally, each step of method 800 may be performed using a computer system. As such, means for performing method 800 include computerized devices, such as mobile phones, computers, tablet computers, servers, etc. Method 800 may represent a more detailed embodiment of method 700 or an entirely separate method.

At step 810, a journal entry may be received. The journal entry may indicate one or more transactions, such as credit and/or debit transactions, that are desired to be posted to a ledger that indicates transactions involving one or more financial (e.g., bank) accounts. As an example, a business may maintain a ledger for all credits and debits to particular financial accounts. The ledger may be used to record where funds originated from and where funds were distributed to (e.g., spent). The journal entry may include information such as: the user submitting the journal entry, a number of credits and/or debits, an amount of each credit and/or debit, the other entity giving or receive the funds, a description of each credit and/or debit, and/or a time and/or date for each transaction. Other information may also be present as part of the journal entry.

As part of the journal entry (or with the journal entry), the user who submitted the journal entry may provide an indication that the journal entry is to be posted to a particular ledger. As such, at step 820, a request to post the journal entry to a ledger may be received. The request may indicate which ledger the journal entry is to be posted to. Submission of the journal entry may be based on a user selecting a graphical element that indicates post. The selection of the user may only indicate that posting will occur or may also indicate that approval will occur prior to posting. Providing only a single input from the user to invoke approval and posting may be possible. As such, based on a single input received from the user, the journal entry may be submitted and received for approval and posting.

Referring to system 200 of FIG. 2, the journal entry may be received by a server, such as host computer system 110 from a remote computer system, such as user computer system 120, operated by the user submitting the journal entry. As such, a journal entry may be submitted from a remote computer system via a network, such as network 140. In some embodiments, the journal entry may be submitted directly to the computer system maintaining the ledger. As such, host computer system 110 may directly receive a journal entry from a user. The journal entry, until approved for posting, may be stored within pending journal entries 117.

At step 830, it may be determined if an approval process is required for the ledger indicated by the journal entry. At step 830 rules specific to the ledger that the journal entry is intended to post to may be analyzed. Referring to FIG. 2, ledger rules 116 may be accessed to determine what, if any, rules apply specifically to the ledger. Some ledgers may not require an approval process. Some ledgers may set a minimum transaction amount that requires an approval process. Such rules may be customized for the business that operates the ledgers and financial accounts. If no approval process is necessary for the ledger the journal entry is intended to post to, method 800 may proceed to step 870. If approval may be required in accordance with the rules of the ledger, method 800 may proceed to step 840.

At step 840, it may be determined whether an approval process is required for the specific user that submitted the journal entry. Referring to FIG. 2, approval process rules 114 may be used. Such rules may define whether specific users are subject to an approval process. Further, such rules may define which other users are required to approve the journal entry. Such a determination may be based on the user's job title (or some other indication or raffl(ing). For instance, based on the user's job title, it may be able to be determined who is the user's manager. In some embodiments, a manager (or some other user with permission to approve the user's journal entries) may be identified as linked with the user in approval process rules 114.

The ledger rules accessed at step 830 and rules specific to the user accessed at step 840 may need to be reconciled. For instance, if a ledger requires an approval process for transactions over $500, but the user is eligible to submit journal entries without approval for up to $1000, a conflict between the rules may be present. A business may define which rules take precedence. The rules of steps 830 and 840 may be enforced using a BPEL process. As such, the BPEL process may be customizable for each business that is maintaining the ledgers. Therefore, the approval process may be tailored to closely fit each business's unique characteristics.

At step 840, if no other users are required to approve the user's journal entry, method 800 may proceed to step 870. If one or more other users are required to approve the journal entry, the specific one or more users may be identified at step 870 and method 800 may proceed to step 850.

At step 850, approval is requested from one or more other users. Such other users may be managers that have permission to approve journal entries of the user that submitted the journal entry received at step 810. The request may be transmitted to the one or more other users. The request may be transmitted to the other users in the form of an email, text message, desktop notification, etc. The request may contain a copy of the journal entry or selected information from the journal entry. The request may provide the ability to directly approve the journal entry. For example, if the request is in the form of an email, a link may be provided to approve the journal entry. In some embodiments, the other user may be required to log into a system to provide approval or denial of the journal entry. The other user may be permitted to modify the journal entry.

If multiple other users are required to approve a journal entry, the approvals may be sent in series or in parallel. In series, a first approval request is sent to a first user. Once approved by the first user, a second approval request is sent to a second user, and so on. In parallel, approval requests are sent to each user that is required to approve the journal entry contemporaneously, meaning that the approval requests are outstanding at the same time. Which approval scheme is used may be customized for a particular businesses, for particular ledgers, and/or for particular users. In some embodiments, approval may be required from a minimum number of a group of users eligible to approve the journal entry. For instance, a request for approval may be transmitted to 5 users, of which 3 must approve the journal entry. Once three have approved, posting may occur. If one of the five users denies the journal entry, posting may be prevented. Other approval schemes are also possible.

Referring to FIG. 3, host computer system 110 may transmit a request for approval to a remote computer system, such as manager computer system 130. If in the form of an email, the manager computer system may be whichever computer system the manager happens to be using to access his or her email. During the approval process, the journal entry may be maintained in a pending state, such as in pending journal entries 117.

A user that is approving the journal entry may be permitted to modify the journal entry. If modified, the user who submitted the journal entry may be notified as such, such as via email. The user may then need to resubmit the journal entry for posting or the approval and posting process may continue without input from the user. Again, this may be customized for a particular business, ledger, and/or user.

At step 860, the approval may be received from the one or more other users. If multiple approvals of the journal entry are required, multiple approvals (or denials) may be received at step 860. Referring to FIG. 4, the approval from the one or more users may be received by host computer system 110 from other computer systems, such as manager computer system 130. In some embodiments, at least some of the other users may directly interact with host computer system 110.

If one (or some other number, greater than zero) of the users denied the posting of the journal entry, method 800 may proceed to step 875. The journal entry may not be posted. The user that submitted the journal entry may be notified that the journal entry was denied. In some embodiments, only specific transactions of the journal entry may be denied. The notification sent to the user of the denial may indicate the reason the journal entry was denied. As such, the user may have the ability to correct and resubmit the journal entry. If this occurs, the journal entry may be passed through the same approval process again.

If, at step 860, the journal entry is approved in accordance with the approval process, posting may occur to the ledger at step 870. Posting to the ledger may include updating the appropriate ledger to reflect the one or more transactions of the journal entry. As such, a final account balance reflected by the ledger may change in response to the transactions of the journal entry. Additional details included in the journal entry may be published to the ledger and may become visible to all users that have permission to view the ledger. Posting to the ledger may automatically occur after all of the requisite approvals have been obtained. As such, from the point of view of the user who submitted the journal entry at step 810 and the posting request at step 820, once the journal entry is submitted with a request to post, no further action is necessary. Therefore, following step 820, no further input is required from the user submitting the journal entry. As such, once the approval process has successfully been completed, the journal entry will be posted to the ledger. The journal entry received at step 810 may be demarked as posted. Referring to FIG. 4, the journal entry may be removed from pending journal entries 117, posted to the appropriate ledger of ledgers 115, and journal entry 210 may be demarked as posted.

At step 880, the user that submitted the journal entry may receive an indication that the submitted journal entry has been successfully posted to the ledger. This may be the first notification received by the user regarding the journal entry since the user submitted the request for posting at step 820. As such, the approval process may have been invisible to the user.

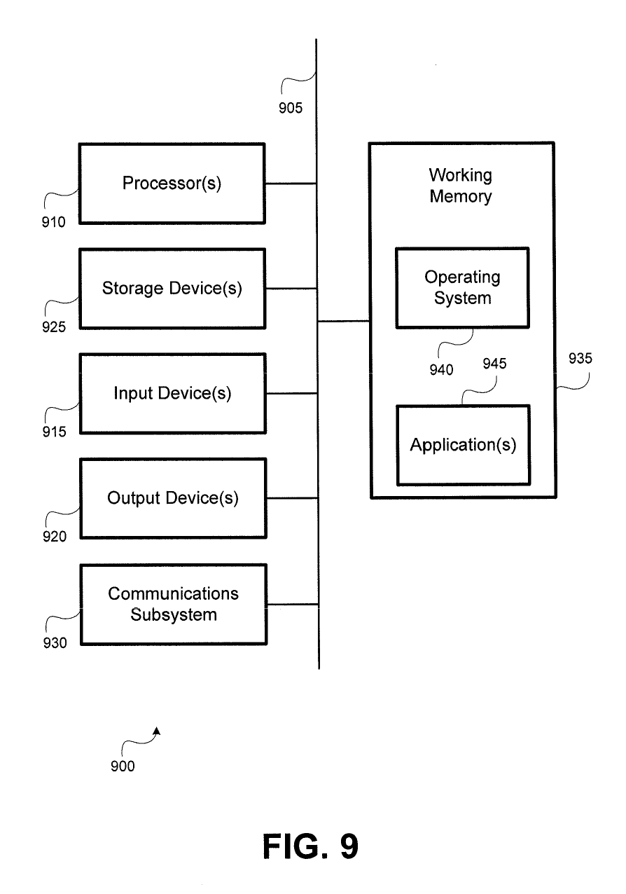

FIG. 9 illustrates an embodiment of a computer system. A computer system as illustrated in FIG. 9 may be incorporated as part of the previously described computerized devices. For example, computer system 900 can represent some or all of the components of the user computer system, manager computer system, and host computer system discussed in this application. FIG. 9 provides a schematic illustration of one embodiment of a computer system 900 that can perform the methods provided by various embodiments, as described herein, and/or can function as the host computer system. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, and/or the like); one or more input devices 915, which can include without limitation a mouse, a keyboard, and/or the like; and one or more output devices 920, which can include without limitation a display device, a printer, and/or the like.

The computer system 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like. Such non-transitory storage device 925 may be used to store the pending journal entries, approval process rules, ledgers, and/or ledger rules described in relation to systems 100 through 400 of FIGS. 1 through 4, respectively.

The computer system 900 might also include a communications subsystem 930, which can include without limitation a modem, a network card (wireless or wired), an infrared communication device, a wireless communication device, and/or a chipset (such as a Bluetooth™ device, an 802.11 device, a WiFi device, a WiMax device, cellular communication facilities, etc.), and/or the like. The communications subsystem 930 may permit data to be exchanged with a network (such as the network described below, to name one example), other computer systems, and/or any other devices described herein. In many embodiments, the computer system 900 will further comprise a working memory 935, which can include a RAM or ROM device, as described above.

Various components of system 900 may be distributed and accessed via a network. As such, multiple components of system 900 may be repeated and/or spread among multiple computer systems.

The computer system 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 900) to perform methods in accordance with various embodiments of the invention. According to a set of embodiments, some or all of the procedures of such methods are performed by the computer system 900 in response to processor 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the storage device(s) 925. Merely by way of example, execution of the sequences of instructions contained in the working memory 935 might cause the processor(s) 910 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 900, various computer-readable media might be involved in providing instructions/code to processor(s) 910 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 925. Volatile media include, without limitation, dynamic memory, such as the working memory 935.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900.

The communications subsystem 930 (and/or components thereof) generally will receive signals, and the bus 905 then might carry the signals (and/or the data, instructions, etc. carried by the signals) to the working memory 935, from which the processor(s) 910 retrieves and executes the instructions. The instructions received by the working memory 935 may optionally be stored on a non-transitory storage device 925 either before or after execution by the processor(s) 910.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined.

Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for posting a journal entry to a ledger, the method comprising:
receiving, by a computer system, from a user, the journal entry that comprises financial information related to a credit or debit from an account, with a request to post the journal entry to the ledger, wherein the journal entry corresponds to the ledger;
determining, by the computer system, that the journal entry is subject to an approval process;
after receiving the request to post the journal entry to the ledger, identifying, by the computer system, at least one other user required to approve the journal entry as part of the approval process;
receiving, by the computer system, an approval from the at least one other user; and
after receiving the approval from the at least one other user, posting the journal entry to the ledger such that the ledger indicates the credit or debit of the journal entry, wherein:
posting of the journal entry to the ledger requires no additional input from the user who submitted the journal entry following receiving the request to post the journal entry to the ledger received with the journal entry.

2. The method for posting the journal entry to the ledger of claim 1, the method further comprising:
determining, by the computer system, using a rule applicable to the ledger, that the ledger is subject to the approval process.

3. The method for posting the journal entry to the ledger of claim 1, wherein:
identifying the at least one other user required to approve the journal entry as part of the approval process is performed using a BPEL business process.

4. The method for posting the journal entry to the ledger of claim 1, wherein:
identifying the at least one other user is at least partially based on a stored indication of a manager of the user.

5. The method for posting the journal entry to the ledger of claim 1, the method further comprising:
transmitting, by the computer system, an approval request to the at least one other user.

6. The method for posting the journal entry to the ledger of claim 1, the method further comprising:
storing, by the computer system, an indication, linked with the journal entry, that indicates the journal entry has posted to the ledger.

7. The method for posting the journal entry to the ledger of claim 1, further comprising:
after receiving the approval from the at least one other user, transmitting a notification to the user indicating the journal entry has been posted to the ledger.

8. A computer program product residing on a non-transitory processor-readable medium for posting a journal entry to a ledger, the computer program product comprising processor-readable instructions configured to cause a processor to:
receive, from a user, the journal entry that comprises financial information related to a credit or debit from an account, with a request to post the journal entry to the ledger, wherein the journal entry corresponds to the ledger;
determine that the journal entry is subject to an approval process;
after receiving the request to post the journal entry to the ledger, identify at least one other user required to approve the journal entry as part of the approval process;
receive an approval from the at least one other user; and
after receiving the approval from the at least one other user, cause the journal entry to be posted to the ledger such that the ledger indicates the credit or debit of the journal entry, wherein:
posting of the journal entry to the ledger requires no additional input from the user who submitted the journal entry following receiving the request to post the journal entry to the ledger received with the journal entry.

9. The computer program product residing on the non-transitory processor-readable medium for posting the journal entry to the ledger of claim 8, the computer program product further comprising processor-readable instructions configured to cause the processor to:
determine, using a rule applicable to the ledger, that the ledger is subject to the approval process.

10. The computer program product residing on the non-transitory processor-readable medium for posting the journal entry to the ledger of claim 8, wherein:
the processor-readable instructions configured to cause the processor to identify the at least one other user required to approve the journal entry as part of the approval process is performed using a BPEL business process.

11. The computer program product residing on the non-transitory processor-readable medium for posting the journal entry to the ledger of claim 8, wherein:
the processor-readable instructions configured to cause the processor to identify the at least one other user, at least partially bases identification on a stored indication of a manager of the user.

12. The computer program product residing on the non-transitory processor-readable medium for posting the journal entry to the ledger of claim 8, the computer program product further comprising processor-readable instructions configured to cause the processor to:
cause an approval request to be transmitted to the at least one other user.

13. The computer program product residing on the non-transitory processor-readable medium for posting the journal entry to the ledger of claim 8, the computer program product further comprising processor-readable instructions configured to cause the processor to:
cause an indication linked with the journal entry to be stored, wherein the indication indicates the journal entry has posted to the ledger.

14. The computer program product residing on the non-transitory processor-readable medium for posting the journal entry to the ledger of claim 8, the computer program product further comprising processor-readable instructions configured to cause the processor to:
after receiving the approval from the at least one other user, cause a notification to the user indicating the journal entry has been posted to the ledger to be transmitted.

15. A system for posting a journal entry to a ledger, the system comprising:
a processor; and
a memory communicatively coupled with and readable by the processor and having stored therein processor-readable instructions which, when executed by the processor, cause the processor to:
receive, from a user, the journal entry that comprises financial information related to a credit or debit from an account, with a request to post the journal entry to the ledger, wherein the journal entry corresponds to the ledger;
determine that the journal entry is subject to an approval process;
after receiving the request to post the journal entry to the ledger, identify at least one other user required to approve the journal entry as part of the approval process;
receive an approval from the at least one other user; and
after receiving the approval from the at least one other user, cause the journal entry to be posted to the ledger such that the ledger indicates the credit or debit of the journal entry, wherein:
posting of the journal entry to the ledger requires no additional input from the user who submitted the journal entry following receiving the request to post the journal entry to the ledger received with the journal entry.

16. The system for posting the journal entry to the ledger of claim 15, the memory further having stored therein processor-readable instructions configured to cause the processor to:
determine, using a rule applicable to the ledger, that the ledger is subject to the approval process.

17. The system for posting the journal entry to the ledger of claim 15, wherein:
the processor-readable instructions configured to cause the processor to identify the at least one other user required to approve the journal entry as part of the approval process is performed using a BPEL business process.

18. The system for posting the journal entry to the ledger of claim 15, wherein:
the processor-readable instructions configured to cause the processor to identify the at least one other user, at least partially bases identification on a stored indication of a manager of the user.

19. The system for posting the journal entry to the ledger of claim 15, the memory further having stored therein processor-readable instructions configured to cause the processor to:
cause an approval request to be transmitted to the at least one other user.

20. The system for posting the journal entry to the ledger of claim 15, the memory further having stored therein processor-readable instructions configured to cause the processor to:
cause an indication linked with the journal entry to be stored, wherein the indication indicates the journal entry has posted to the ledger.
